(19) United States
(12) Patent Application Publication
(10) Pub. No.: US 2007/0267284 A1
(43) Pub. Date: Nov. 22, 2007

(54) Micro switch

(76) Inventor: Lai Cheng-Tsai, Ilan (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/435,879

(22) Filed: May 18, 2006

(51) Int. Cl. H01H 5/00

(52) U.S. Cl. 200/402

(57) ABSTRACT

A micro switch includes a housing, which has bottom terminal slots and an inside locating hole, a side cover hooked on the housing and covering a side opening of the housing, and a common terminal and a normal-open terminal respectively mounted in the bottom terminal slots, the common terminal and the normal-open terminal each having a first end extending out of the housing and a second end extending through the locating hole inside the housing.

### BACKGROUND OF THE INVENTION

1. Field of the Invention

The present invention relates to electric switches and more specifically, to a micro switch, which keeps the normal-open terminal, the common terminal and the metal spring firmly secured to the inside of the housing in position.

2. Description of the Related Art

A conventional electrical signal connector, as shown in FIGS. 1 and 2, comprises a housing 100. The housing 100 has an opening 101 at one side covered with a side cover 200. The side cover 200 has a plurality of hooks 201 hooked in respective hook holes 102 on the housing 100 to secure the housing 100 and the side cover 200 together. The side cover 200 has a side flange 202. The housing 100 has a button slot 104 cut through the top wall thereof for accommodating a button 90. The button 90 has two wings 91 respectively outwardly extending from two opposite sides thereof and respectively stopped below the button slot 104 inside the housing 100 to prevent falling of the button 90 out of the housing 100.

The housing 100 has a cushion 130 with a groove 131 at the bottom, a block 140 adjacent to the groove 131, a terminal slot 103 cut through the bottom wall between the groove 131 and the block 140. A normal-open terminal 150 is fastened to the groove 131, having one end extending to the outside of the housing 100 through the terminal slot 103 and the other end extending over the block 140.

The housing 100 further has a slot 161 at one side for the mounting of a common terminal 170. The common terminal 70 has one end extending through the slot 161 to the inside of the housing 100 and terminating in two upright supports 171 that are pressed against the top wall of the housing 100 disposed at two sides relative to the button 90, which is mounted in the top side of the housing 100. When the user presses the button 90, the upright supports 171 support the top wall of the housing 100 against deformation.

Further, a movable plate 180 is coupled to the upright supports 171 of the common terminal 170, having one end affixed to the bottom side of the top wall of the housing 100. The movable plate 180 has a first opening 181 and a second opening 182. The openings 181 and 182 are disposed adjacent to each other and have different sizes. The first opening 181 has one side edge that is far from the second opening 182 engaged into a retaining notch 172 of one upright support 171 of the common terminal 170. A plate spring 183 is provided at one side of the second opening 182 such that when the second opening 182 is coupled to the other support 171 of the common terminal 17, the free end of the plate spring 183 is engaged into the retaining notch 172 of the corresponding upright support 171, thereby securing the common terminal 170 and the movable plate 180 together. The movable plate 180 is disposed in contact with the bottom side of the button 90.

According to the aforesaid design, the normal-open terminal 150 is positioned in between the groove 131 and the block 140. During fabrication of the switch, the block 140 must be mounted inside the housing 100 or directly formed integral with the bottom wall of the housing 100. Further, the block 140 must be kept spaced from the groove 131 at a suitable distance. Further, the top of the normal-open terminal 150 must be configured to have a substantially C-shaped profile fitting the block 140. If the opening of the C-shaped profile does not fit the vertical thickness of the block 140 perfectly, the block 140 cannot support the normal-open terminal 150 firmly in position.

### SUMMARY OF THE INVENTION

The present invention has been accomplished under the circumstances in view. According to one aspect of the present invention, the micro switch comprises a housing, which has bottom terminal slots and an inside locating hole, a side cover hooked on the housing and covering a side opening of the housing, and a common terminal and a normal-open terminal respectively mounted in the bottom terminal slots, the common terminal and the normal-open terminal each having a first end extending out of the housing and a second end extending through the locating hole inside the housing. By means of the bottom terminal slots and the locating hole, the common terminal and the normal-open terminal are firmly secured to the housing. According to another aspect of the present invention, a movable plate is coupled to the common terminal inside the housing to support a button in the top side of the housing, having one end pressed on a protruding portion inside the housing to prevent falling of the movable plate out of the common terminal when the button is pressed by the user to deform the movable plate.

### BRIEF DESCRIPTION OF THE DRAWING

FIG. 1 is an exploded view of an electrical signal connector according to the prior art.

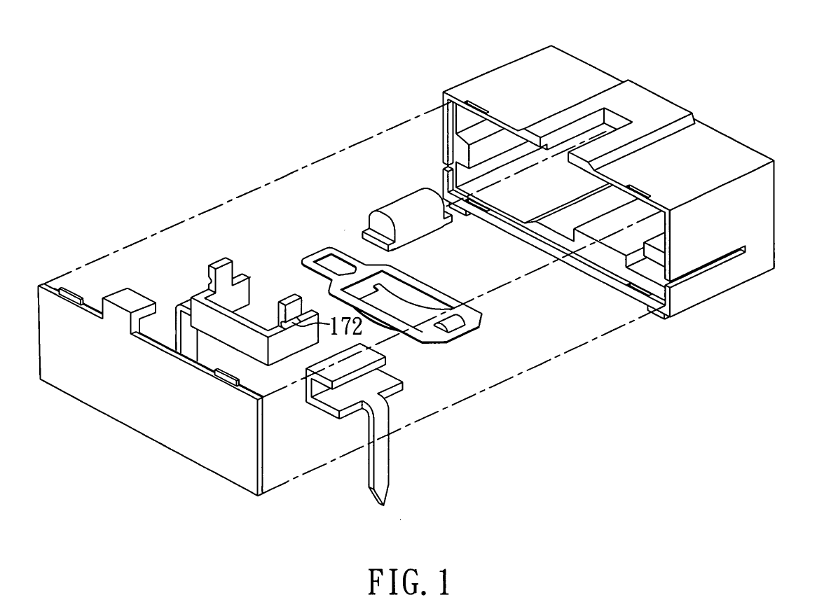

FIG. 2 is a sectional assembly view of the electrical signal connector according to the prior art.

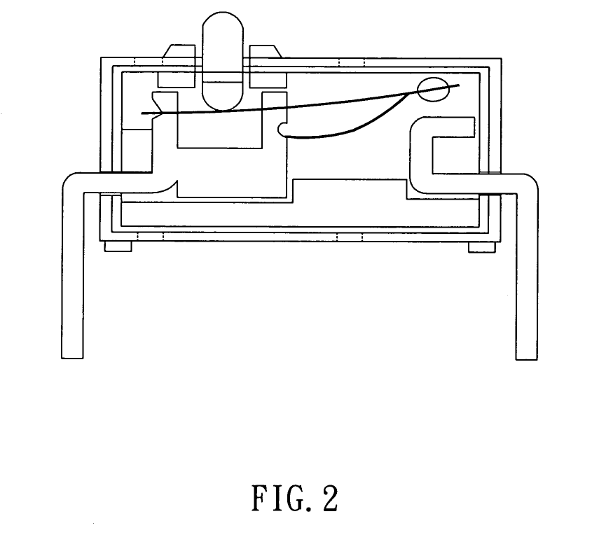

FIG. 3 is an exploded view of a micro switch according to the present invention.

FIG. 4 is a sectional assembly view of the micro switch according to the present invention.

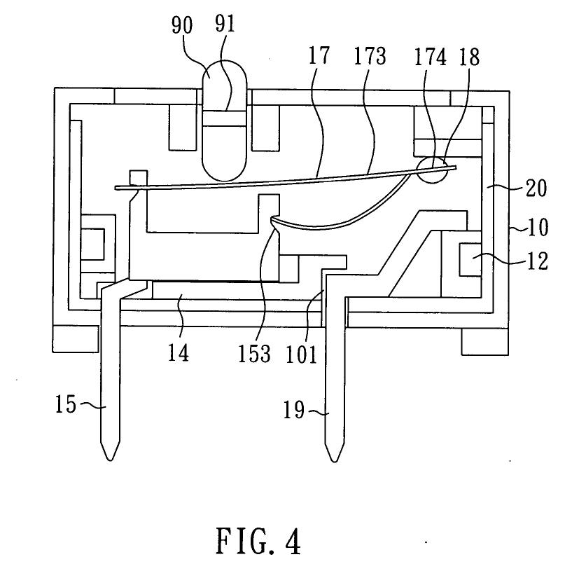

FIG. 5 is an oblique elevation of the present invention, showing the outer appearance of the micro switch.

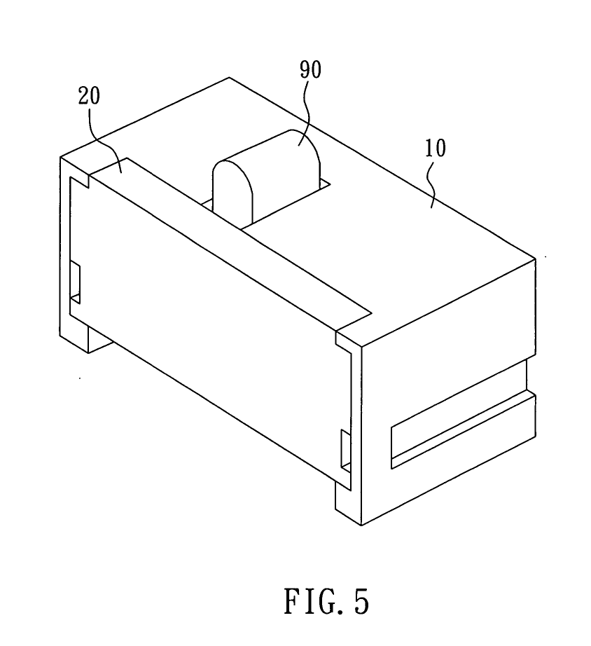

### DETAILED DESCRIPTION OF THE PREFERRED EMBODIMENT

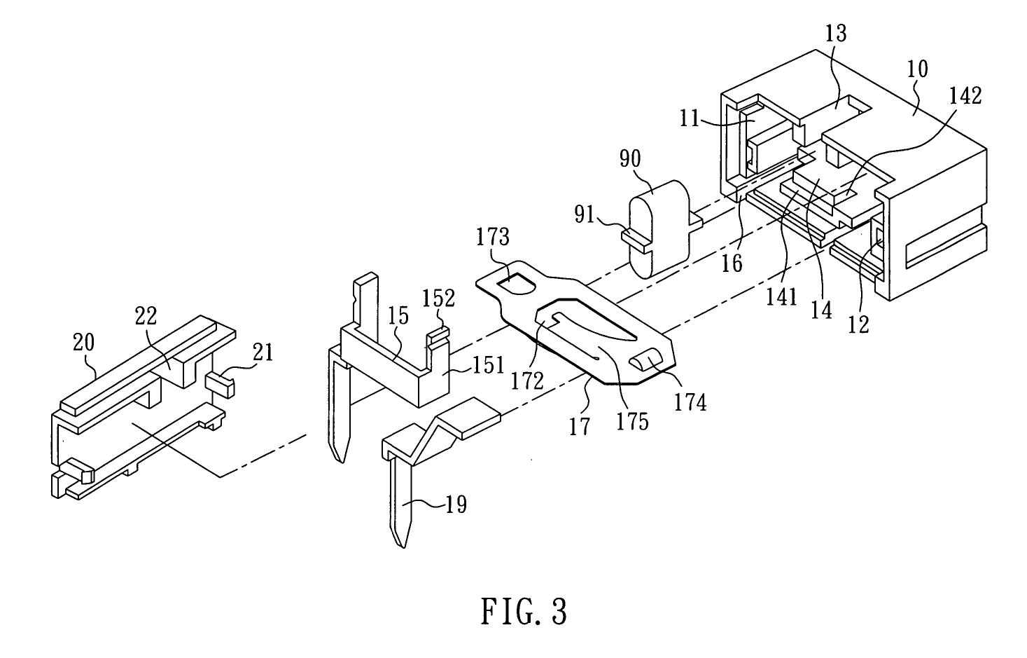

Referring to FIGS. 3˜5, a micro switch in accordance with the present invention is shown comprised of a housing 10. The housing 10 has an opening 11 at one side covered with a side cover 20. The side cover 20 has a plurality of hooks 21 hooked in respective hook holes 12 on the housing 10 to secure the housing 10 and the side cover 20 together. The side cover 20 has a side flange 22. The housing 10 has a button slot 13 cut through the top wall thereof for accommodating a button 90. The button 90 has two wings 91 respectively outwardly extending from two opposite sides thereof and respectively stopped below the button slot 13 inside the housing 10 to prevent falling of the button 90 out of the housing 10.

The housing 10 has a horizontal locating member 14 suspending on the inside and spaced from the top and bottom walls of the housing 10 at a distance. The horizontal locating member 14 has a horizontal locating groove 141 and a top slot 142 vertically cut through the top wall thereof in communication with the horizontal locating groove 141. A common terminal 15 is fastened to the horizontal locating groove 141, having one end extended out of the housing 10 through one of the two bottom terminal slots 16 on the bottom wall of the housing 10 and the other end extending through a locating hole 101 adjacent to the other bottom terminal slot 16 toward the top side of the housing 10 via the top slot 142 of the horizontal locating member 14. By means of the locating hole 101 and the horizontal locating member 14, the common terminal 15 is firmly secured to the housing 10 against displacement.

The common terminal 15 has two upwardly extending supports 151. According to this embodiment, the supports 151 are flat bars each having a retaining notch 152. A movable plate 17 is coupled to the supports 151. The movable plate 17 has a first opening 171 and a second opening 172 disposed adjacent to each other. The first opening 171 and the second opening 172 have different sizes. The first opening 171 has one side edge that is far from the second opening 172 engaged into the retaining notch 152 of one support 151 of the common terminal 15. A plate spring 173 is provided at one side of the second opening 172 such that when the second opening 172 is coupled to the other support 151 of the common terminal 15, the free end of the plate spring 173 is engaged into the retaining notch 152 of the corresponding support 151, thereby securing the common terminal 15 and the movable plate 17 together. The movable plate 17 is disposed in contact with the bottom side of the button 90. Further, the movable plate 17 has a raised locating portion 174 disposed at one end remote from the common terminal 15 and pressed on a protruding portion 18 on the inside wall of the housing 10 to prevent falling of the movable plate 17 from the common terminal 15 when the button 90 is pressed by the user and the movable plate 17 is deformed by the button 90.

Further, a normal-open terminal 19 is mounted in the other bottom terminal slot 16 of the housing 10 and extending out of the bottom wall of the housing 10. The upper part of the normal-open terminal 19 is zigzagged. The zigzagged upper part of the normal-open terminal 19 configures two horizontal planes disposed at different elevations. The lower horizontal plane of the zigzagged upper part of the normal-open terminal 19 is pressed on the top surface of the bottom wall of the housing 10 adjacent to the bottom terminal slot 16. The upper horizontal plane of the zigzagged upper part of the normal-open terminal 19 is extended through the locating hole 101 and then pressed on a locating portion 12 inside the housing 10. Under this mounting arrangement, the normal-open terminal 19 is firmly secured to the housing 10. This mounting design of micro switch is quite simple and easy to manufacture, thereby saving much manufacturing cost.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A micro switch comprising:
a housing, said housing having at least one bottom terminal slot cut through a bottom wall thereof, an opening at one side thereof, and a locating hole disposed on the inside adjacent to one of said at least one bottom terminal slot;
a side cover hooked on said housing and covering said opening of said housing; and
a common terminal and a normal-open terminal respectively mounted in said at least one bottom terminal slot, said common terminal and said normal-open terminal each having a first end extending out of said housing and a second end extending through said locating hole inside said housing.

2. The micro switch as claimed in claim 1, wherein said housing comprises a locating member, said locating member having a horizontal locating groove and a vertical top slot in communication with said horizontal locating groove for the positioning of the second end of said common terminal.

3. The micro switch as claimed in claim 1, wherein the second end of said normal-open terminal is a zigzagged, configuring an upper horizontal plane and a lower horizontal plate, said lower horizontal plane being pressed on a top surface of the bottom wall of said housing adjacent to one of said at least one bottom terminal slot, said upper horizontal plane being extended through said locating hole and pressed on a part inside said housing.

4. The micro switch as claimed in claim 1, wherein said housing has a button slot accommodating a button, and a plurality of hook holes; said side cover has a side flange stopped inside said housing, and a plurality of hooks respectively hooked in the hook holes of said housing.
